(19) United States
(12) Patent Application Publication
(10) Pub. No.: US 2004/0125458 A1
(43) Pub. Date: Jul. 1, 2004

(54) Light guide plate and method for fabricating same

(76) Inventors: Ga-Lane Chen, Fremont, CA (US); Charles Leu, Fremont, CA (US); Tai-Cheng Yu, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/737,678

(22) Filed: Dec. 15, 2003

(30) Foreign Application Priority Data
Dec. 13, 2002 (TW) 91136040

(51) Int. Cl. G02B 5/02; B29D 11/00

(52) U.S. Cl. 359/599; 264/1.7

(57) ABSTRACT

A light guide plate (LGP) (3) includes a transparent plate (31) and a waterproof layer (32). The transparent plate has a light emitting surface (311) on a top thereof, and a bottom surface (312) opposite to the light emitting surface. The waterproof layer is disposed over the light emitting surface. A preferred method for fabricating the LGP includes the steps of: (a) providing an transparent plate having a light emitting surface on a top thereof and a bottom surface opposite to the light emitting surface; and (b) forming a waterproof layer over the light emitting surface.

### BACKGROUND OF THE INVENTION

1. Field of the Invention

The present invention relates to light guide plates (LGPs) and methods for fabricating them.

2. Description of Prior Art

A typical liquid crystal display (LCD) device comprises an LCD panel and a backlight system mounted under the LCD panel for supplying light beams thereto. The backlight system mainly comprises a light source and an LGP. The LGP is normally a transparent polymer plate, and is used for guiding the light beams emitted by the light source in order to uniformly illuminate the LCD panel.

A conventional LGP 2 as shown in FIG. 5 has a light emitting surface 21, and a bottom surface 22 with a plurality of projections 221 thereon. However, there is no structure to protect the LGP 2 from intrusion by water or humidity. As a result, the LGP 2 is easily distorted when cleaned or when used in a humid environment. This leads to poorer optical performance, which can be very substantial when the LGP 2 is large.

### SUMMARY OF THE INVENTION

Accordingly, an object of the present invention is to provide an LGP which has a dimensional stability when used in a humid environment.

Another object of the present invention is to provide a method for fabricating an LGP as described in the previous paragraph.

In order to achieve the objects set out above, an LGP in accordance with the present invention comprises a transparent plate and a waterproof layer. The transparent plate has a light emitting surface on a top thereof, and a bottom surface opposite to the light emitting surface. The waterproof layer is disposed over the light emitting surface. Alternatively, another waterproof layer may be formed over the bottom surface.

A preferred method for fabricating the LGP of the present invention comprises the steps of: (1) providing a transparent plate having a light emitting surface on a top thereof and a bottom surface opposite to the light emitting surface; and (2) forming a waterproof layer over the light emitting surface.

These and other features, aspects and advantages of the present invention will become more apparent from the following detailed description and claims, and from the accompanying drawings in which:

### BRIEF DESCRIPTION OF THE DRAWINGS

FIG. 1 is a perspective view of an LGP with a waterproof layer in accordance with a first embodiment of the present invention;

FIG. 2 is a schematic side elevation of infrastructure used in manufacturing a waterproof layer of the LGP of FIG. 1 by dipping, in accordance with a preferred method of the present invention;

FIG. 3 is an end elevation of an LGP with two waterproof layers in accordance with a second embodiment of the present invention;

FIG. 4 is an end elevation of an LGP in accordance with a third embodiment of the present invention, the LGP being similar to that of the first embodiment but having a plurality of projections formed on a bottom surface thereof; and

FIG. 5 is an end elevation of a conventional LGP.

### DETAILED DESCRIPTION OF THE PRESENT INVENTION

Reference will now be made to the drawings to describe the present invention in detail.

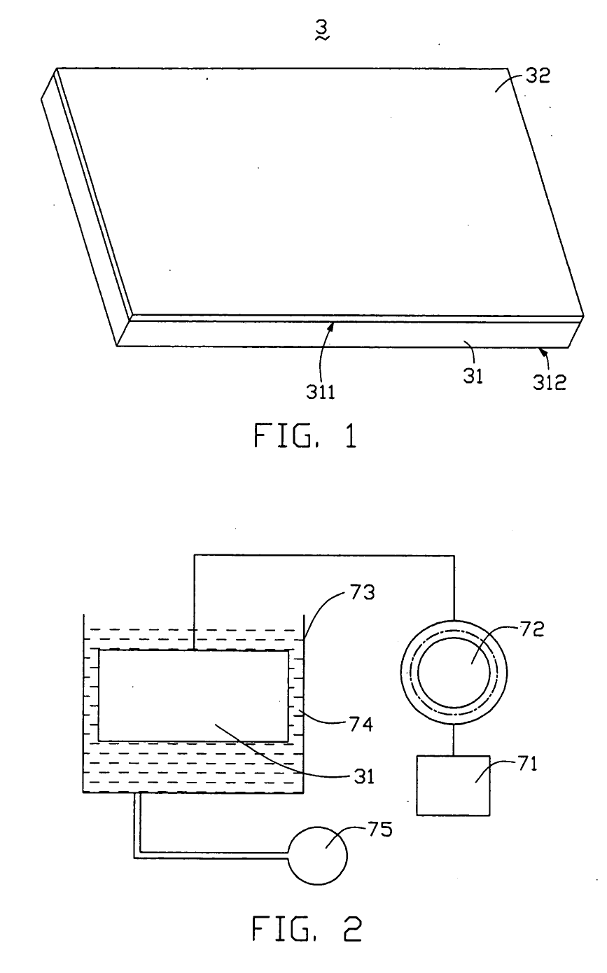

Referring to FIG. 1, an LGP 3 in accordance with a first embodiment of the present invention comprises a transparent plate 31 and a waterproof layer 32. The transparent plate 31, which is a substantially rectangular body, has a light emitting surface 311 on a top thereof and a bottom surface 312 opposite to the light emitting surface 311. The transparent plate 31 is generally made from polymethyl methacrylate (PMMA) or polycarbonate (PC). The waterproof layer 32 is disposed over the light emitting surface 311, thus protecting the transparent plate 31 from being distorted when the LGP 3 is cleaned or used in a humid environment. As a result, the LGP 3 has a good dimensional stability and optical performances.

Referring also to FIG. 2, a preferred process for manufacturing the waterproof layer 32 is by dipping. A preferred method of the present invention for manufacturing the waterproof layer 32 comprises the steps of:

(1) providing the transparent plate 31 having the light emitting surface 311 on the top thereof and the bottom surface 312 opposite to the light emitting surface 311; and

(2) forming the waterproof layer 32 over the light emitting surface 311.

In step (1), surfaces of the transparent plate 31 other than the light emitting surface 311 are shielded from dipping. For example, these surfaces are coated with a material such as triacetate.

In step (2), a motor 71, a set of gears 72, a tank 73 and a pump 75 are mainly used. The tank 73 is filled with liquid 74, and is used for immersion of the transparent plate 31. The motor 71 meshing with the gears 72 moves the transparent plate 31 up and down in the tank 73. At the same time, the pump 75 controls a level (not labeled) of the liquid 74 to ensure that the transparent plate 31 is submerged. Due to surface tension, the liquid 74 becomes coated on the light emitting surface 311, and thus forms the waterproof layer 32. A thickness of the waterproof layer 32 can be gauged by a Fourier transform infrared gauge (not shown).

Typically, the liquid 74 is hydrophilic polyurethane resin, and a temperature of the liquid 74 is about 40° C. during dipping.

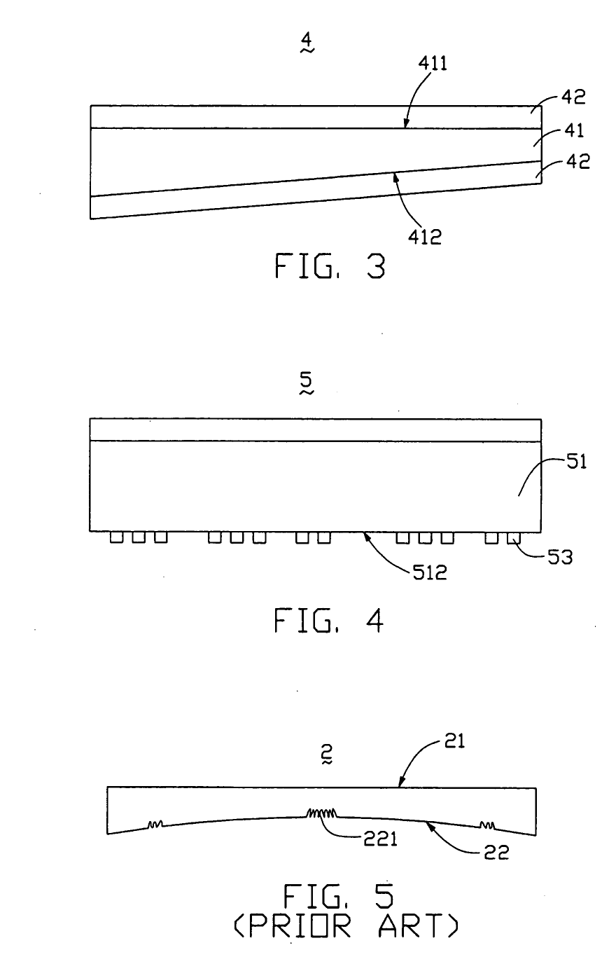

FIG. 3 is an end elevation of an LGP 4 according to a second embodiment of the present invention. Compared with the LGP 3 of the first embodiment, two waterproof layers 42 are respectively formed on a light emitting surface 411 and on a bottom surface 412, and furthermore a transparent plate 41 is substantially wedge-shaped.

FIG. 4 is an end elevation of an LGP 5 according to a third embodiment of the present invention. Compared with the LGP 3 of the first embodiment, a plurality of projections 53 is formed on a bottom surface 512 of the transparent plate 51 for diffusing light.

It is also noted that because of the added waterproof layer 32, the original possible thermal induced stress of the transparent plate 31 may be interacted with the thin film stress of the waterproof layer 32 for reducing the possible deformation.

While the present invention has been described with reference to particular embodiments, the description is illustrative of the invention and is not to be construed as limiting the invention. Therefore, various modifications of the described embodiments can be made by those skilled in the art without departing from the true spirit and scope of the invention as defined by the appended claims.

What is claimed is:

1. A light guide plate comprising:
a transparent plate having a light emitting surface on a top thereof and a bottom surface opposite to the light emitting surface; and
a waterproof layer disposed over the light emitting surface.

2. The light guide plate as recited in claim 1, wherein a plurality of projections is formed on the bottom surface for diffusing light.

3. The light guide plate as recited in claim 1, wherein the waterproof layer is a waterproof film.

4. The light guide plate as recited in claim 1, wherein another waterproof layer is formed on the bottom surface.

5. The light guide plate as recited in claim 1, wherein the waterproof layer is made from hydrophilic polyurethane resin.

6. The light guide plate as recited in claim 1, wherein the waterproof layer is coated on the light emitting surface by dipping.

7. The light guide plate as recited in claim 1, wherein the transparent plate is made from polymethyl methacrylate or polycarbonate.

8. The light guide plate as recited in claim 4, wherein the other waterproof layer is made from hydrophilic polyurethane resin.

9. The light guide plate as recited in claim 4, wherein the other waterproof layer is coated on the bottom surface by dipping.

10. The light guide plate as recited in claim 1, wherein said waterproof layer provides a thin film stress interacting with a thermal induced stress derived from the transparent plate so as to eliminate distortion of the light guide plate.

11. A method for fabricating a light guide plate, the method comprising the steps of:
(1) providing a transparent plate having a light emitting surface on a top thereof and a bottom surface opposite to the light emitting surface; and
(2) forming a waterproof layer over the light emitting surface.

12. The method as recited in claim 11, further including forming another waterproof layer on the bottom surface.

13. The method as recited in claim 11, further including forming a plurality of projections on the bottom surface, for diffusion of light.

14. The method as recited in claim 11, wherein the waterproof layer is coated on the light emitting surface by dipping.

15. The method as recited in claim 11, wherein the waterproof layer is made from hydrophilic polyurethane resin.

16. The method as recited in claim 11, wherein the transparent plate is made from polymethyl methacrylate or polycarbonate.

17. The method as recited in claim 12, wherein the other waterproof layer is coated on the light emitting surface by dipping.

18. The method as recited in claim 12, wherein the other waterproof layer is made from hydrophilic polyurethane resin.
